(19) United States
(12) Patent Application Publication
(10) Pub. No.: US 2024/0012188 A1
(43) Pub. Date: Jan. 11, 2024

(54) PATTERNED OPTICAL FILM

(71) Applicant: BenQ Materials Corporation, Taoyuan (TW)

(72) Inventors: Chen-Kuan Kuo, Taoyuan (TW); Chung-Yuan Cheng, Taoyuan (TW); Wei-Feng Xu, Taoyuan (TW); Cyun-Tai Hong, Taoyuan (TW)

(73) Assignee: BenQ Materials Corporation, Taoyuan (TW)

(21) Appl. No.: 18/311,270

(22) Filed: May 3, 2023

(30) Foreign Application Priority Data
Jul. 7, 2022 (TW) 111125588

(51) Int. Cl. G02B 5/30

(52) U.S. Cl. CPC G02B 5/3016

(57) ABSTRACT

Disclosed is a patterned optical film, comprising a patterned alignment layer having a plurality of striped retardation regions arranged in strips with different depths, a liquid crystal filling layer provided to cover and planarize the striped retardation regions, and a polarizing layer disposed on the liquid crystal filling layer.

### CROSS-REFERENCE TO RELATED APPLICATION

This application claims the priority benefit of Taiwanese Application Serial Number 111125588, filed on Jul. 7, 2022, which is incorporated herein by reference.

### FIELD OF THE INVENTION

The invention relates to a patterned optical film, and more particularly to a patterned optical film used on the surface of an electroluminescence display, which has the effect of producing a plurality of patterns formed by areas with different hues of reflected light.

### BACKGROUND OF THE INVENTION

As people have more requirements for the aesthetics and functionalities of the display, the demand for various displays to match the surrounding environment has increased. For example, when the vehicle display is turned off, it generally displays a black screen, but the interior of the vehicle may have different colors and material texture. Therefore, if the display screen when the vehicle display is turned off can be consistent with the color and material texture of the surrounding interior, a better matching effect can be achieved.

In order to achieve the above-mentioned effects, it is known that a decorative film with the same color and texture can be used to attach to the surface of the display to make it consistent with the interior. However, the decorative film greatly reduces the light transmittance of the displayed image of the display, and after the image light passes through the decorative film, it is easy to cause image color deviation and interference due to the color tone and texture of the decorative film.

Therefore, the inventor of the present invention proposes a patterned optical film. When the patterned optical film is used on the surface of a self-illuminating electroluminescent display, it can produce different colors and textures through the reflection of external ambient light in the dark state, and the original image contrast and color tone of the display Image light in the bright state can be maintained without interference.

### SUMMARY OF THE INVENTION

The present inventors disclose a patterned optical film to provide a solution for the current products.

In an embodiment of the present invention, a patterned optical film comprises a patterned alignment layer having a plurality of striped retardation regions arranged in strips with different depths; a liquid crystal filling layer provided to cover and planarize the striped retardation regions; and a polarizing layer disposed on the liquid crystal filling layer.

In an embodiment of the present invention, the depths of the striped retardation regions of the patterned alignment layer are in a range of 0.1 μm to 30 μm.

In another embodiment of the present invention, the cross-sectional widths of the striped retardation regions perpendicular to the alignment direction of the patterned alignment layer is are a range of 0.05 mm to 50 mm.

In another embodiment of the present invention, the striped retardation regions of the patterned alignment layer are distributed continuously or discontinuously in the alignment direction.

In another embodiment of the present invention, the retardations of the striped retardation regions are in a range of 80 nm to 600 nm.

In another embodiment of the present invention, the optical axes of the liquid crystal filling layer corresponding to the striped retardation regions are the same or different.

In another embodiment of the present invention, the liquid crystal filling layer is a regular wavelength dispersion liquid crystal filling layer, a reversed wavelength dispersion liquid crystal filling layer or a cholesteric liquid crystal filling layer.

In another embodiment of the present invention, the polarization degree of the polarizing layer is in a range of 50% to 99.999%.

In another embodiment of the present invention, the transmittance of the polarizing layer is in a range of 35% to 60%.

In another embodiment of the present invention, the polarizing layer is an absorbing polarizing layer, a reflective polarizing layer, a dyed-type polarizing layer, a coating-type polarizing layer, a grating polarizing layer or a combination thereof.

In another embodiment of the present invention, the patterned optical film further comprises a functional film disposed on the surface of the polarizing layer, and the functional film is a heat-insulation film, an explosion-proof film, a hard coating film, an antifouling film, an antiglare film, an antireflection film or a combination thereof.

### BRIEF DESCRIPTION OF THE DRAWINGS

FIG. 1 is a cross-sectional view of a patterned optical film of an embodiment of the present invention.

FIG. 2 is a perspective view of a patterned optical film of an embodiment of the present invention applied to an electroluminescent display.

FIG. 3 is a cross-sectional view of a patterned optical film of another embodiment of the present invention.

### DETAILED DESCRIPTION OF THE INVENTION

With reference to the following more detailed description and claims taken in conjunction with the accompanying drawings. The purpose of the drawings is only for illustrating the present invention and may not exhibit the true proportions and precise configuration. Thus, the drawings cannot be used limit the concept and scope of the present invention. The present disclosure is only defined by the appended claims.

The following description together with the accompanying drawings is to illustrate embodiments of the patterned optical film of the present invention. For understanding, the same elements in the following embodiments are described with the same symbols.

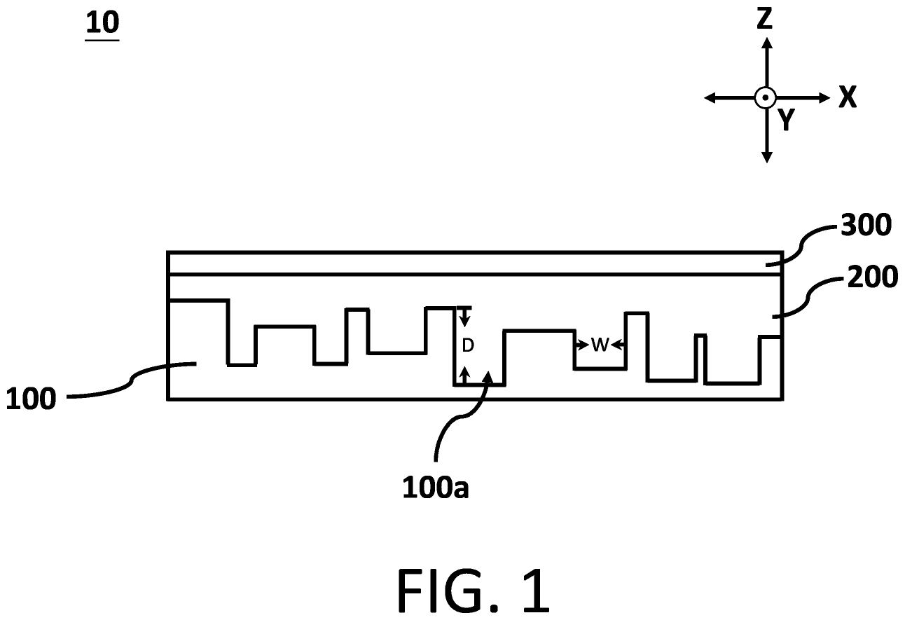

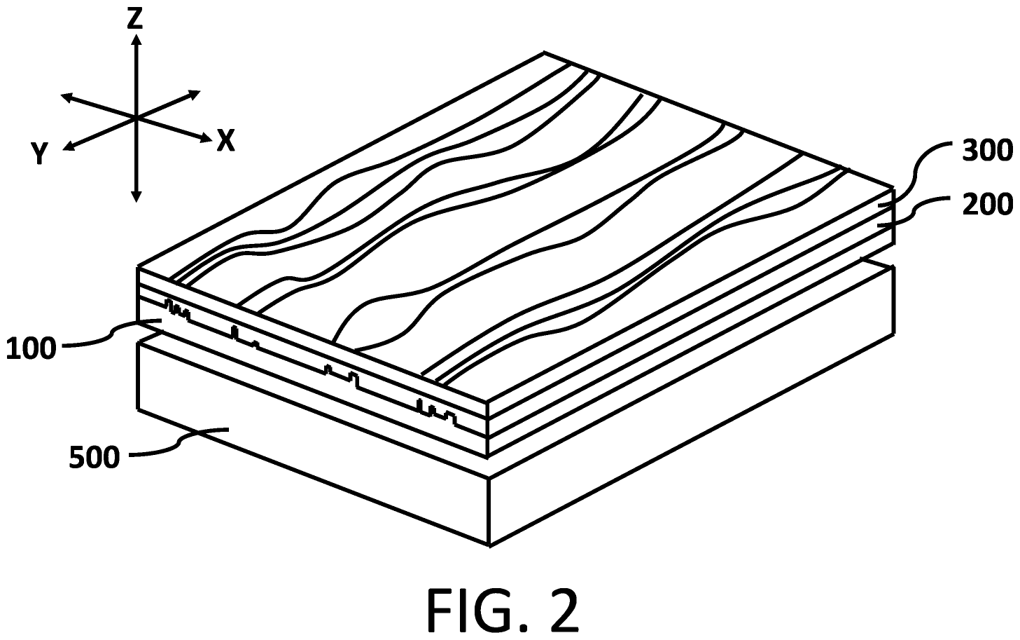

Referring to FIG. 1 and FIG. 2, in an embodiment of the present invention, a patterned optical film 10 is disclosed. The patterned optical film 10 comprises a patterned alignment layer 100 having a plurality of striped retardation regions 100a arranged in strips with different depths (for example, along the Y-axis direction shown in the figures); a liquid crystal filling layer 200 provided to cover and planarize the striped retardation regions 100a; and a polarizing layer 300 disposed on the liquid crystal filling layer 200.

In another embodiment of the present invention, the depths of the striped retardation regions 100a of the patterned alignment layer 100 are in a range of 0.1 μm to 30 μm.

In another embodiment of the present invention, the cross-sectional widths (W) of the striped retardation regions 100a perpendicular to the alignment direction (Y-axis direction) of the patterned alignment layer 100 are in a range of 0.05 mm to 50 mm.

In another embodiment of the present invention, the striped retardation regions 100a of the patterned alignment layer 100 are distributed continuously or discontinuously in the alignment direction (Y-axis direction).

In another embodiment of the present invention, the retardations of the striped retardation regions 100a are in a range of 80 nm to 600 nm.

Referring to FIG. 2, when the external ambient light (not shown in the figure) enters the patterned optical film 10, it is reflected by electrodes of an electroluminescent display 500, which can form preset pattern textures and different colors due to the different reflectivity of different visible light wavelengths on the different retardations generated from the striped retardation regions 100a of the patterned optical film 10. Since the pattern textures and colors are formed by adjusting the reflectivity of reflected light, instead of forming by attaching a colored decorative film to filter light, the light transmittance of the display image light emitted by the electroluminescent display 500 will not be reduced, and the electroluminescent display 500 with the patterned optical film 10 has a better display image light intensity than that with the colored decorative film.

In another embodiment of the present invention, the optical axes (not shown) of the liquid crystal filling layer 200 corresponding to the striped retardation regions 100a are the same or different.

In another embodiment of the present invention, the liquid crystal filling layer 200 is a regular wavelength dispersion liquid crystal filling layer, a reversed wavelength dispersion liquid crystal filling layer or a cholesteric liquid crystal filling layer.

In another embodiment of the present invention, the polarization degree of the polarizing layer 300 is in a range of 50% to 99.999%.

In another embodiment of the present invention, the transmittance of the polarizing layer 300 is in a range of 35% to 60%.

In another embodiment of the present invention, the polarizing layer 300 is an absorbing polarizing layer, a reflective polarizing layer, a dyed-type polarizing layer, a coating-type polarizing layer, a grating polarizing layer or a combination thereof.

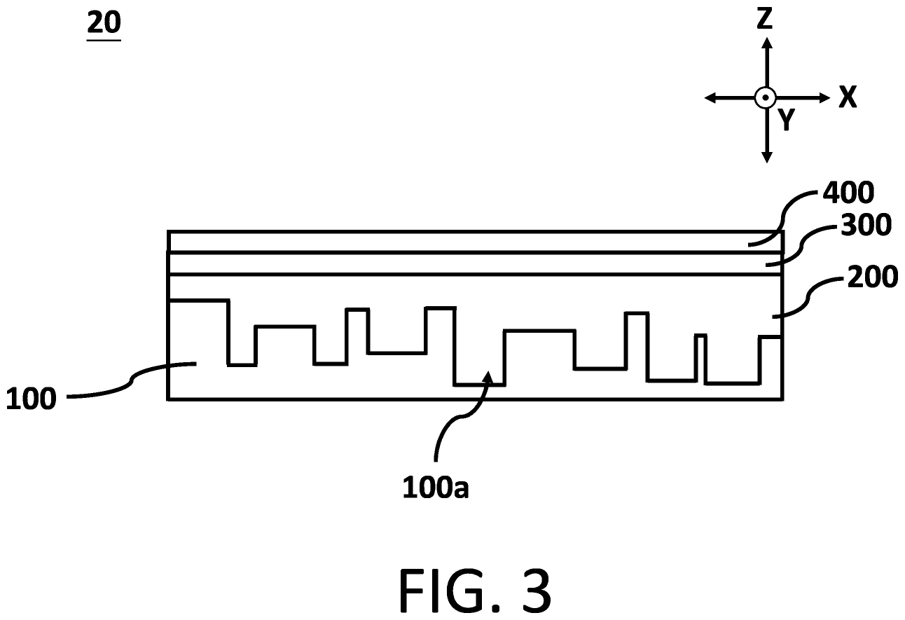

Referring to FIG. 3, in another embodiment of the present invention, the patterned optical film 20, which is roughly similar to the patterned optical film 10 shown in FIG. 1, comprises a patterned alignment layer 100 having a plurality of striped retardation regions 100a arranged in strips with different depths (for example, along the Y-axis direction shown in the figures); a liquid crystal filling layer 200 provided to cover and planarize the striped retardation regions 100a; and a polarizing layer 300 disposed on the liquid crystal filling layer 200, and further comprises a functional film 400 disposed on the surface of the polarizing layer 300, wherein the functional film 400 is a heat-insulation film, an explosion-proof film, a hard coating film, an antifouling film, an antiglare film, an antireflection film or a combination thereof.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A patterned optical film, comprising:
a patterned alignment layer having a plurality of striped retardation regions arranged in strips with different depths;
a liquid crystal filling layer provided to cover and planarize the striped retardation regions; and
a polarizing layer disposed on the liquid crystal filling layer.

2. The patterned optical film according to claim 1, wherein depths of the striped retardation regions of the patterned alignment layer are in a range of 0.1 μm to 30 μm.

3. The patterned optical film according to claim 1, wherein cross-sectional widths of the striped retardation regions perpendicular to an alignment direction of the patterned alignment layer are in a range of 0.05 mm to 50 mm.

4. The patterned optical film according to claim 1, wherein the striped retardation regions of the patterned alignment layer are distributed continuously or discontinuously in an alignment direction.

5. The patterned optical film according to claim 1, wherein the retardations of the striped retardation regions are in a range of 80 nm to 600 nm.

6. The patterned optical film according to claim 1, wherein the liquid crystal filling layer has optical axes corresponding to the striped retardation regions, and the optical axes are the same or different.

7. The patterned optical film according to claim 1, wherein the liquid crystal filling layer is a regular wavelength dispersion liquid crystal filling layer, a reversed wavelength dispersion liquid crystal filling layer or a cholesteric liquid crystal filling layer.

8. The patterned optical film according to claim 1, wherein a polarization degree of the polarizing layer is in a range of 50% to 99.999%.

9. The patterned optical film according to claim 1, wherein a transmittance of the polarizing layer is in a range of 35% to 60%.

10. The patterned optical film according to claim 1, wherein the polarizing layer is an absorbing polarizing layer, a reflective polarizing layer, a dyed-type polarizing layer, a coating-type polarizing layer, a grating polarizing layer or a combination thereof.

11. The patterned optical film according to claim 1, further comprising a functional film disposed on the surface of the polarizing layer, wherein the functional film is a heat-insulation film, an explosion-proof film, a hard coating film, an antifouling film, an antiglare film, an antireflection film or a combination thereof.
